(19) United States
(12) Patent Application Publication
(10) Pub. No.: US 2010/0145751 A1
(43) Pub. Date: Jun. 10, 2010

(54) VALIDATION METHOD AND SYSTEM

(76) Inventors: Charles Franklin Berry, Apalachin, NY (US); Glenn C. Godoy, Endwell, NY (US); Amy Jeanne Snavely, Binghamton, NY (US)

Correspondence Address: SCHMEISER, OLSEN & WATTS, 22 CENTURY HILL DRIVE, SUITE 302, LATHAM, NY, 12110, US

(21) Appl. No.: 12/331,482

(22) Filed: Dec. 10, 2008

(51) Int. Cl. G06Q 10/00; G06Q 30/00

(52) U.S. Cl. 705/7; 705/30

(57) ABSTRACT

A validation method and system. The method includes receiving, by a computing system, accounting data and an associated purchasing document. The computing system receives a request for validating the accounting data. The computing system determines a purchasing scenario associated with the purchasing document. The computing system receives a configuration table and validation algorithms. The configuration table comprises accounting elements each comprising parameters. The computing system selects relevant accounting elements from the configuration table. The computing system selects relevant algorithms of the validation algorithms. The computing system executes each relevant algorithm of the validation algorithms on an associated set of parameters of the parameters. The computing system generates validation statuses for the relevant accounting elements. The computing system transmits validation statuses to a calling system.

### FIELD OF THE INVENTION

The present invention relates to a method and associated system for validating statuses for accounting elements.

### BACKGROUND OF THE INVENTION

Determining that input data comprises acceptable data typically comprises a complicated and inefficient process with little flexibility. A user requesting the input data may not have the ability to associate the input data with purchasing information. Accordingly, there exists a need in the art to overcome at least some of the deficiencies and limitations described herein above.

### SUMMARY OF THE INVENTION

The present invention provides a validation method comprising:

receiving, by a computing system, accounting data and a purchasing document, wherein said accounting data is associated with said purchasing document;

receiving; by said computing system from a calling system, a request for validating said accounting data;

determining, by said computing system based on said request, a purchasing scenario associated with said purchasing document;

receiving, by said computing system, a configuration table and validation algorithms, wherein said configuration table comprises accounting elements, wherein each accounting element of said accounting elements comprises parameters, and wherein said validation algorithms comprise rules associated with said accounting elements;

selecting, by said computing system, relevant accounting elements from said configuration table, wherein said relevant accounting elements are associated with said purchasing scenario;

selecting, by said computing system, relevant algorithms of said validation algorithms, wherein said relevant algorithms are associated with said relevant accounting elements;

executing, by said computing system, each algorithm of said validation algorithms on an associated set of parameters of said parameters;

generating, by said computing system in response to said executing, validation statuses for said relevant accounting elements comprising each said associated set of parameters; and

transmitting, by said computing system to said calling system, said validation statuses.

The present invention provides a computing system comprising a processor coupled to a computer-readable memory unit, said memory unit comprising instructions that when executed by the processor implement a validation method, said method comprising:

receiving, by said computing system, accounting data and a purchasing document, wherein said accounting data is associated with said purchasing document;

receiving, by said computing system from a calling system, a request for validating said accounting data;

determining, by said computing system based on said request, a purchasing scenario associated with said purchasing document;

receiving, by said computing system, a configuration table and validation algorithms, wherein said configuration table comprises accounting elements, wherein each accounting element of said accounting elements comprises parameters, and wherein said validation algorithms comprise rules associated with said accounting elements;

selecting, by said computing system, relevant accounting elements from said configuration table, wherein said relevant accounting elements are associated with said purchasing scenario;

selecting, by said computing system, relevant algorithms of said validation algorithms, wherein said relevant algorithms are associated with said relevant accounting elements;

executing, by said computing system, each algorithm of said validation algorithms on an associated set of parameters of said parameters;

generating, by said computing system in response to said executing, validation statuses for said relevant accounting elements comprising each said associated set of parameters; and

transmitting, by said computing system to said calling system, said validation statuses.

The present invention provides a computer program product, comprising a computer readable medium comprising a computer readable program code embodied therein, said computer readable program code adapted to implement a validation method within a computing system comprising a computer-readable memory unit, said method comprising:

receiving, by said computing system, accounting data and a purchasing document, wherein said accounting data is associated with said purchasing document;

receiving, by said computing system from a calling system, a request for validating said accounting data;

determining, by said computing system based on said request, a purchasing scenario associated with said purchasing document;

receiving, by said computing system, a configuration table and validation algorithms, wherein said configuration table comprises accounting elements, wherein each accounting element of said accounting elements comprises parameters, and wherein said validation algorithms comprise rules associated with said accounting elements;

selecting, by said computing system, relevant accounting elements from said configuration table, wherein said relevant accounting elements are associated with said purchasing scenario;

selecting, by said computing system, relevant algorithms of said validation algorithms, wherein said relevant algorithms are associated with said relevant accounting elements;

executing, by said computing system, each algorithm of said validation algorithms on an associated set of parameters of said parameters;

generating, by said computing system in response to said executing, validation statuses for said relevant accounting elements comprising each said associated set of parameters; and

transmitting, by said computing system to said calling system, said validation statuses.

The present invention provides process for supporting computer infrastructure, said process comprising providing at least one support service for at least one of creating, integrating, hosting, maintaining, and deploying computer-readable code in a computing system comprising a computer-readable memory unit, wherein the code in combination with the computing system is capable of performing a validation method, said method comprising:

receiving, by said computing system, accounting data and a purchasing document, wherein said accounting data is associated with said purchasing document;

receiving, by said computing system from a calling system, a request for validating said accounting data;

determining, by said computing system based on said request, a purchasing scenario associated with said purchasing document;

receiving, by said computing system, a configuration table and validation algorithms, wherein said configuration table comprises accounting elements, wherein each accounting element of said accounting elements comprises parameters, and wherein said validation algorithms comprise rules associated with said accounting elements;

selecting, by said computing system, relevant accounting elements from said configuration table, wherein said relevant accounting elements are associated with said purchasing scenario;

selecting, by said computing system, relevant algorithms of said validation algorithms, wherein said relevant algorithms are associated with said relevant accounting elements;

executing, by said computing system, each algorithm of said validation algorithms on an associated set of parameters of said parameters;

generating, by said computing system in response to said executing, validation statuses for said relevant accounting elements comprising each said associated set of parameters; and transmitting, by said computing system to said calling system, said validation statuses.

The present invention advantageously provides a simple method and associated system capable of determining that input data comprises acceptable data.

### BRIEF DESCRIPTION OF THE DRAWINGS

FIG. 1 illustrates a system for validating statuses for accounting elements, in accordance with embodiments of the present invention.

FIG. 2 illustrates a flowchart describing an algorithm used by the system of FIG. 1 for validating statuses for accounting elements, in accordance with embodiments of the present invention.

FIG. 3 illustrates a table depicting a subset of configuration data used by the software application of FIG. 1 for determining a purchasing document business scenario, in accordance with embodiments of the present invention.

FIG. 4 illustrates a table depicting a complete set of relevant element types for the example purchasing scenario of FIG. 4, in accordance with embodiments of the present invention.

FIG. 5 illustrates a computer apparatus used for validating statuses for accounting elements, in accordance with embodiments of the present invention.

### DETAILED DESCRIPTION OF THE INVENTION

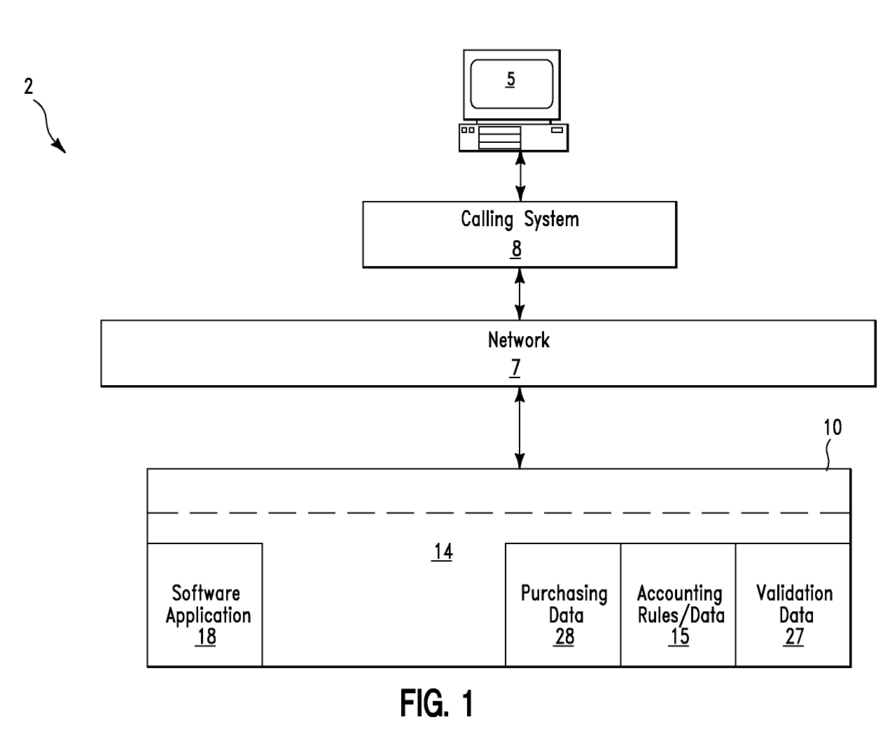

FIG. 1 illustrates a system 2 for validating statuses for accounting elements, in accordance with embodiments of the present invention. Accounting elements comprise portions of accounting data and are defined by types. For example, accounting elements may comprise, inter alia, a cost center, cost center under which other cost centers are organized, a profit center, and a business area. System 2 of FIG. 1 comprises an input/output (I/O) device 5 and a calling system 8 connected to a computing system 10 through a network 7. Calling system 8 is used by a user (i.e., via I/O device 5) for transmitting purchasing data 28 to computing system 10. In return, computing system 10 generates validation data 27 comprising validation statuses for accounting elements. I/O device 5 may comprise any type of I/O device such as, inter alia, a notebook computer, a desktop computer, a personal digital assistant (PDA), etc. Network 7 may comprise any type of network including, inter alia, a local area network, (LAN), a wide area network (WAN), the Internet, etc. Computing system 10 may comprise any type of computing system(s) including, inter alia, a personal computer (PC), a server computer, a database computer, etc. Computing system 10 comprises a memory system 14. Memory system 14 comprises software application 18, purchasing data 28, validation data 27, and accounting rules/data 15 (e.g., data associated with: purchases, purchase types, rules for making purchases, accounting input forms). Accounting rules/data 15 comprise accounting element validation rules that are order less and independent. The accounting element validation rules operate on elements which are configured as relevant for a specific business scenario. Additionally, a validation process associated with an accounting element may be configured by an algorithm and required parameters. In order to validate statuses for accounting elements, a purchasing scenario (i.e., inputted into computing system 10) is used to retrieve a subset of all relevant accounting element types from a database (e.g., memory system 14). A purchasing scenario is defined herein as a multi-element delimited key comprising a corporation ID, a document type, a purchase type, a dependent entity, a country, and a company. An entity (e.g., a corporation) may comprise multiple organizations (e.g., multiple internal companies or entities). A dependent entity is defined herein as an entity (e.g., a corporation, a company, etc) that relies on an originating entity (e.g., a governing entity) for its day to day operations and must continue to use computing services, application systems, and underlying business processes of the originating entity until the dependent entity may establish or migrate to its own systems. For example, a company A (e.g., a computer monitor company) has been divested or sold from a governing company B (e.g., a computer manufacturer) to another company C (e.g., a television manufacturer). Employees that were formally employed by company B are currently employed by company C but must rely on company B's applications for day to day business operations during a transition period to ensure uninterrupted production. During this transition period, company A is considered to be a dependent company or entity.

System 2 is used for validating statuses for accounting elements using the following steps:

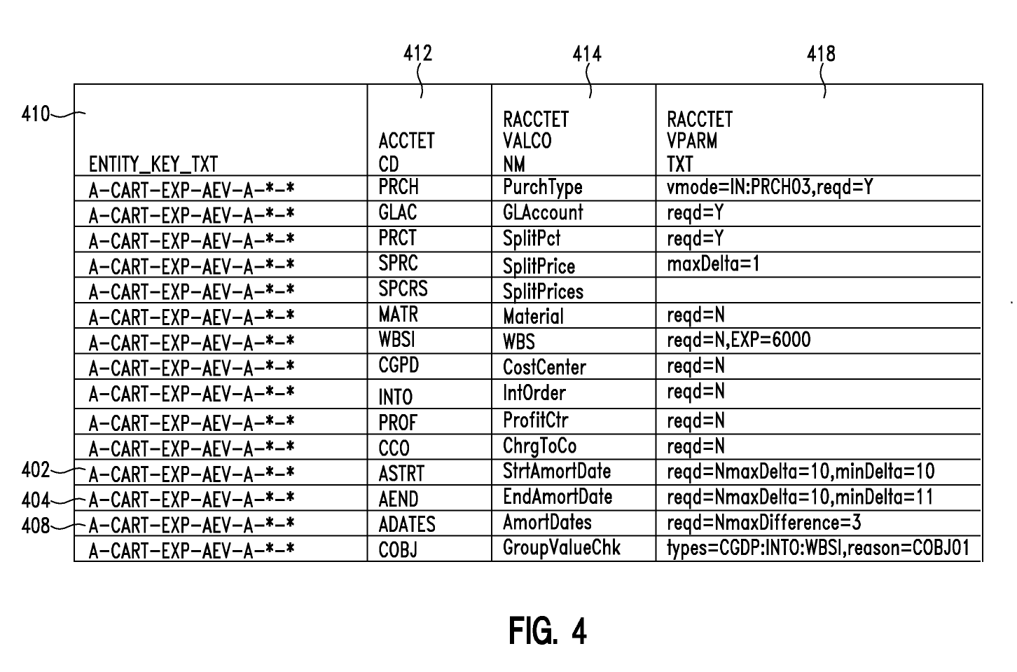

1. A request for validation (i.e., of accounting elements) is transmitted to computing system 10. The request is generated by a calling application (i.e., calling system 8). The calling application transmits a web service call and a generic accounting document to computing system 10. The generic accounting document comprises accounting elements, a corporation ID, a document type, and a purpose code.
2. A purchasing scenario is determined. The purchasing scenario is a multi-element delimited key made up of a corporation ID, a document type, a purchase type, a dependent entity, a country, and a company. Computing system 10 extracts a purchase type (e.g., expense, resale, capital, etc.), a country, and a company from a generic accounting document which was transmitted during the web service call.
3. Validation rules are retrieved. Computing system uses a right-to-left wild carded best fit mechanism for comparing the purchasing scenario to a configuration table (e.g., a spreadsheet) of relevant accounting elements. A list of matches is extracted from this table and associated validation algorithms and parameters are processed. Each accounting element is treated as an independent entity so therefore pseudo accounting elements are used to specify relationships between elements. For example, during an expense purchase (i.e., when a purchase is being made against pre-paid expenses), a user is required to enter amortization start and end dates. (e.g., codes ASTRT and AEND in the spreadsheet of FIG. 4). For each individual date, business rules for validation involve ensuring that:
A. A value is specified if required
B. A date is not too far into the past
C. A date is not too far into the future.
Additionally, a business rule is used that specifies that the two dates may not be more than three years apart. Since the validation rules are order less and independent, the user may not check the relationship between the two dates while validating either date, since the user is unaware if the other date has been validated yet. Therefore, a pseudo accounting element (e.g., ADATES in the spreadsheet of FIG. 4) is independently validated. A validation rule for this element specifies that the two dates are not more than some configurable amount of time apart.
4. Validation algorithms are retrieved. Computing system 10 comprises a complete set of actual and pseudo accounting elements. Therefore, computing system 10 may call each associated validation algorithm without any type of ordering. Parameters specified in the configuration table are passed into each algorithm. A relationship between dates may be validated before the dates' associated individual values are validated. For example, the dates may be within three years of each other (i.e., valid) but the start date is too far into the past. In this case, ADATES will validate but ASTRT will throw an error back to the caller.
5. A validation status for each accounting element is returned to calling system 8. Calling system 8 may receive a response of yes, no, or a list of errors.

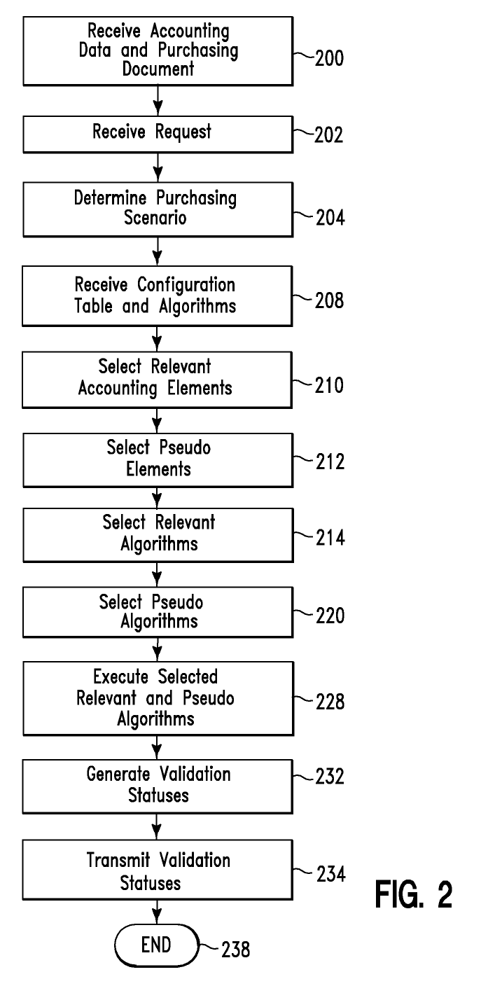

FIG. 2 illustrates a flowchart describing an algorithm used by system 2 of FIG. 1 for validating statuses for accounting elements, in accordance with embodiments of the present invention. In step 200, a computing system (e.g., computing system 10 of FIG. 1) receives from a calling system (e.g., calling system 8 of FIG. 1), accounting data (e.g., accounting rules/data 15 of FIG. 1) and a purchasing document (e.g., purchasing data 28 of FIG. 1). The accounting data is associated with the purchasing document. In step 202, the computing system receives (i.e., from the calling system) a request for validating the accounting data. In step 204, the computing system determines (i.e., base on the request of step 202) a purchasing scenario associated with the purchasing document. In step 208, computing system receives a configuration table and validation algorithms. The configuration table comprises accounting elements. Each accounting element comprises parameters. The validation algorithms comprise rules associated with the accounting elements. In step 210, the computing system selects relevant accounting elements from the configuration table. The relevant accounting elements are associated with the purchasing scenario determined in step 204. The relevant accounting elements each comprise an associated identification code in the configuration file. In step 212, the computing system selects pseudo accounting elements from the configuration table. The pseudo accounting elements are associated with the relevant accounting elements (i.e., pseudo accounting elements comprise relationships between sets of relevant accounting elements). In step 214, the computing system selects relevant algorithms of the validation algorithms. The relevant algorithms are associated with the relevant accounting elements. In step 220, the computing system selects pseudo algorithms of the validation algorithms. The pseudo algorithms are associated with said sets of the relevant accounting elements. In step 228, the computing system executes each algorithm selected in step 214 on an associated set of parameters from the configuration table. Additionally, in step 228, the computing system executes each pseudo algorithm selected in step 220 on an associated set of pseudo parameters from the configuration table. The algorithms and pseudo algorithms may be executed in any order, including, inter alia, a random order. In step 232, the computing system generates (i.e., based on the algorithm execution of step 228) validation statuses for the relevant accounting elements. In step 234, the computing system transmits the validation statuses to the calling system and the process terminates in step 238.

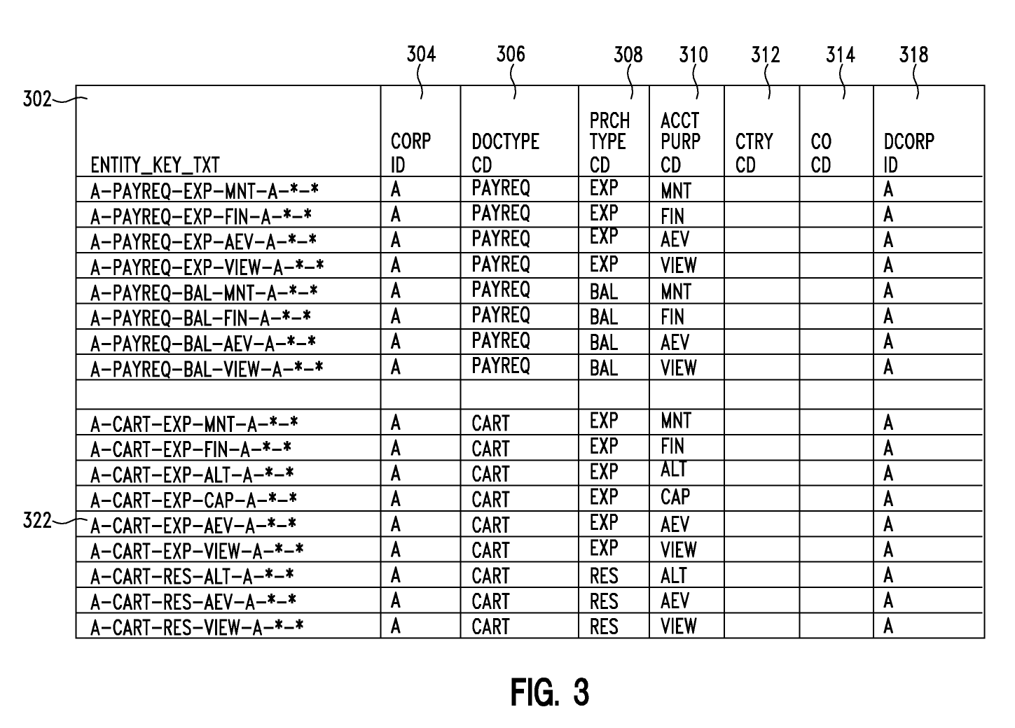

FIG. 3 illustrates a table depicting a subset of configuration data used by software application 18 of FIG. 1 for determining a purchasing document business scenario, in accordance with embodiments of the present invention. The purchasing scenario is used to determine processing to be performed by software application 18. The purchasing document comprises the following data elements (i.e., data elements which are used to identify a specific purchasing scenario):

1. Corporation identification 304.
2. Document type code 306.
3. Purchasing type code 308.
4. Accounting purpose code 310.
5. Country code 312.
6. Company code 314.
7. A dependant corporation identifier 318.

ENTITY_KEY_TEXT 302 comprises an alternate means for identifying a specific purchasing scenario, ENTITY_KEY_TEXT 302 simplifies an algorithm used to find the purchasing scenario which applies to the purchasing document. In the example illustrated in FIG. 3, a calling application (e.g., calling system 8 of FIG. 1) requests that software application 18 validates accounting data located in an online shopping cart (i.e., the purchasing document) according to company A accounting rules and expensed items that are being consumed by a US based company A sub-company. Data located within the purchasing document is used to find purchasing scenario 322 (i.e. A-CART-EXP-AEV-A-*-*). In this example, the items are being consumed by the US based company A sub-company are of little importance. The validation process is common to all company A sub-companies anywhere in the world. Software application 18 obtains only those data element types (accounting element types) and their associated validation algorithms that are relevant in the context of the purchasing scenario.

FIG. 4 illustrates a table depicting a complete set of relevant element types for the example purchasing scenario of FIG. 4, in accordance with embodiments of the present invention. Configuration entries 402, 404, and 408 illustrate an example of the order less and independent nature of the validation method.

1. ENTITY_KEY_TXT 410 comprises a character string naming a specific purchase scenario.
2. ACCTET_CD 412 (i.e., accounting element type) captures an abbreviated name for an accounting attribute. For example, an account number (GLAC), a cost center identifier (CGDP), an amortization start date (ASTRT), a related set of accounting attributes, etc. A pair of amortization dates (ADATES) that bound the start and end dates (ASTRT and AEND respectively) for a period during which items are amortized is an example of a related set of accounting attributes.
3. RACCTET_VALGO_NM 414 (i.e., a validation algorithm) is used to name a piece of application code comprising an algorithm used specifically for validating accounting element types. The validation may be performed as accounting data is being entered by an end-user of software application 18 or as an independent step after accounting data is entered.
4. RACCTET_VPARM_TXT 418 (i.e., an associated validation algorithm parameter string) provides a means to tailor the behavior of the algorithm to meet the specific needs of the validation process within the context of the purchasing scenario. For example, AmortDates algorithm in one purchasing scenario may be mandatory and allow a difference between the start and end dates of five years, while for another scenario the dates are optional and the maximum time period is three years.

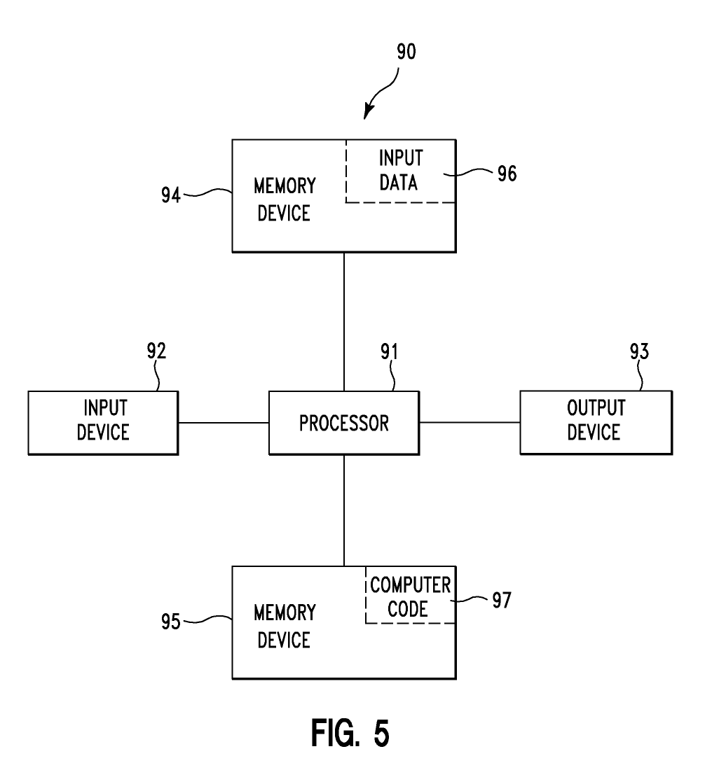

FIG. 5 illustrates a computer apparatus 90 (e.g., computing system 10 of FIG. 1) used for validating statuses for accounting elements, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithm of FIG. 2) for validating statuses for accounting elements. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 5) may comprise the algorithm of FIG. 2 and may be used as a computer usable medium (or a computer readable medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise said computer usable medium (or said program storage device).

Still yet, any of the components of the present invention could be created, integrated, hosted, maintained, deployed, managed, serviced, etc. by a service provider who offers to validate statuses for accounting elements. Thus the present invention discloses a process for deploying, creating, integrating, hosting, maintaining, and/or integrating computing infrastructure, comprising integrating computer-readable code into the computer system 90, wherein the code in combination with the computer system 90 is capable of performing a method for validating statuses for accounting elements. In another embodiment, the invention provides a business method that performs the process steps of the invention on a subscription, advertising, and/or fee basis. That is, a service provider, such as a Solution Integrator, could offer to validate statuses for accounting elements. In this case, the service provider can create, maintain, support, etc. a computer infrastructure that performs the process steps of the invention for one or more customers. In return, the service provider can receive payment from the customer(s) under a subscription and/or fee agreement and/or the service provider can receive payment from the sale of advertising content to one or more third parties.

While FIG. 5 shows the computer system 90 as a particular configuration of hardware and software, any configuration of hardware and software, as would be known to a person of ordinary skill in the art, may be utilized for the purposes stated supra in conjunction with the particular computer system 90 of FIG. 5. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A validation method comprising:
receiving, by a computing system, accounting data and a purchasing document, wherein said accounting data is associated with said purchasing document;
receiving, by said computing system from a calling system, a request for validating said accounting data;
determining, by said computing system based on said request, a purchasing scenario associated with said purchasing document;
receiving, by said computing system, a configuration table and validation algorithms, wherein said configuration table comprises accounting elements, wherein each accounting element of said accounting elements comprises parameters, and wherein said validation algorithms comprise rules associated with said accounting elements;
selecting, by said computing system, relevant accounting elements from said configuration table, wherein said relevant accounting elements are associated with said purchasing scenario;
selecting, by said computing system, relevant algorithms of said validation algorithms, wherein said relevant algorithms are associated with said relevant accounting elements;
executing, by said computing system, each algorithm of said validation algorithms on an associated set of parameters of said parameters;
generating, by said computing system in response to said executing, validation statuses for said relevant accounting elements comprising each said associated set of parameters; and
transmitting, by said computing system to said calling system, said validation statuses.

2. The method of claim 1, further comprising:
selecting, by said computing system, pseudo accounting elements from said configuration table, wherein said pseudo accounting elements are associated with said relevant accounting elements, wherein said pseudo accounting elements comprise relationships between sets of relevant accounting elements of said relevant accounting elements;
selecting, by said computing system, pseudo algorithms of said validation algorithms, wherein said pseudo algorithms are associated with said sets of relevant accounting elements; and
executing, by said computing system, each algorithm of said pseudo algorithms on an associated set of pseudo parameters of said parameters, wherein said generating said validation statuses is based on said executing each said algorithm of said pseudo algorithms on an associated set of pseudo parameters of said parameters.

3. The method of claim 1, wherein said relevant accounting elements each comprise an associated identification code in said configuration file.

4. The method of claim 1, wherein said purchasing scenario comprises a multi-element delimited key comprising an ID for an entity, a document type, a purchase type, a dependent entity, and a specified country.

5. The method of claim 1, wherein said executing each said algorithm of said validation algorithms is performed in a random order.

6. A computing system comprising a processor coupled to a computer-readable memory unit, said memory unit comprising instructions that when executed by the processor implement a validation method, said method comprising:
receiving, by said computing system, accounting data and a purchasing document, wherein said accounting data is associated with said purchasing document;
receiving, by said computing system from a calling system, a request for validating said accounting data;
determining, by said computing system based on said request, a purchasing scenario associated with said purchasing document;
receiving, by said computing system, a configuration table and validation algorithms, wherein said configuration table comprises accounting elements, wherein each accounting element of said accounting elements comprises parameters, and wherein said validation algorithms comprise rules associated with said accounting elements;
selecting, by said computing system, relevant accounting elements from said configuration table, wherein said relevant accounting elements are associated with said purchasing scenario;
selecting, by said computing system, relevant algorithms of said validation algorithms, wherein said relevant algorithms are associated with said relevant accounting elements;
executing, by said computing system, each algorithm of said validation algorithms on an associated set of parameters of said parameters;
generating, by said computing system in response to said executing, validation statuses for said relevant accounting elements comprising each said associated set of parameters; and
transmitting, by said computing system to said calling system, said validation statuses.

7. The computing system of claim 6, wherein said method further comprises:
selecting, by said computing system, pseudo accounting elements from said configuration table, wherein said pseudo accounting elements are associated with said relevant accounting elements, wherein said pseudo accounting elements comprise relationships between sets of relevant accounting elements of said relevant accounting elements;
selecting, by said computing system, pseudo algorithms of said validation algorithms, wherein said pseudo algorithms are associated with said sets of relevant accounting elements; and
executing, by said computing system, each algorithm of said pseudo algorithms on an associated set of pseudo parameters of said parameters, wherein said generating said validation statuses is based on said executing each said algorithm of said pseudo algorithms on an associated set of pseudo parameters of said parameters.

8. The computing system of claim 6, wherein said relevant accounting elements each comprise an associated identification code in said configuration file.

9. The computing system of claim 6, wherein said purchasing scenario comprises a multi-element delimited key comprising an ID for an entity, a document type, a purchase type, a dependent entity, and a specified country.

10. The computing system of claim 6, wherein said executing each said algorithm of said validation algorithms is performed in a random order.

11. A computer program product, comprising a computer readable medium comprising a computer readable program code embodied therein, said computer readable program code adapted to implement a validation method within a computing system comprising a computer-readable memory unit, said method comprising:
receiving, by said computing system, accounting data and a purchasing document, wherein said accounting data is associated with said purchasing document;
receiving, by said computing system from a calling system, a request for validating said accounting data;
determining, by said computing system based on said request, a purchasing scenario associated with said purchasing document;
receiving, by said computing system, a configuration table and validation algorithms, wherein said configuration table comprises accounting elements, wherein each accounting element of said accounting elements comprises parameters, and wherein said validation algorithms comprise rules associated with said accounting elements;
selecting, by said computing system, relevant accounting elements from said configuration table, wherein said relevant accounting elements are associated with said purchasing scenario;
selecting, by said computing system, relevant algorithms of said validation algorithms, wherein said relevant algorithms are associated with said relevant accounting elements;
executing, by said computing system, each algorithm of said validation algorithms on an associated set of parameters of said parameters;
generating, by said computing system in response to said executing, validation statuses for said relevant accounting elements comprising each said associated set of parameters; and
transmitting, by said computing system to said calling system, said validation statuses.

12. The computer program product of claim 11, wherein said method further comprises:
selecting, by said computing system, pseudo accounting elements from said configuration table, wherein said pseudo accounting elements are associated with said relevant accounting elements, wherein said pseudo accounting elements comprise relationships between sets of relevant accounting elements of said relevant accounting elements;
selecting, by said computing system, pseudo algorithms of said validation algorithms, wherein said pseudo algorithms are associated with said sets of relevant accounting elements; and
executing, by said computing system, each algorithm of said pseudo algorithms on an associated set of pseudo parameters of said parameters, wherein said generating said validation statuses is based on said executing each said algorithm of said pseudo algorithms on an associated set of pseudo parameters of said parameters.

13. The computer program product of claim 11, wherein said relevant accounting elements each comprise an associated identification code in said configuration file.

14. The computer program product of claim 11, wherein said purchasing scenario comprises a multi-element delimited key comprising an ID for an entity, a document type, a purchase type, a dependent entity, and a specified country.

15. The computer program product of claim 11, wherein said executing each said algorithm of said validation algorithms is performed in a random order.

16. A process for supporting computer infrastructure, said process comprising providing at least one support service for at least one of creating, integrating, hosting, maintaining, and deploying computer-readable code in a computing system comprising a computer-readable memory unit, wherein the code in combination with the computing system is capable of performing a validation method, said method comprising:
receiving, by said computing system, accounting data and a purchasing document, wherein said accounting data is associated with said purchasing document;
receiving, by said computing system from a calling system, a request for validating said accounting data;
determining, by said computing system based on said request, a purchasing scenario associated with said purchasing document;
receiving, by said computing system, a configuration table and validation algorithms, wherein said configuration table comprises accounting elements, wherein each accounting element of said accounting elements comprises parameters, and wherein said validation algorithms comprise rules associated with said accounting elements;
selecting, by said computing system, relevant accounting elements from said configuration table, wherein said relevant accounting elements are associated with said purchasing scenario;
selecting, by said computing system, relevant algorithms of said validation algorithms, wherein said relevant algorithms are associated with said relevant accounting elements;
executing, by said computing system, each algorithm of said validation algorithms on an associated set of parameters of said parameters;
generating, by said computing system in response to said executing, validation statuses for said relevant accounting elements comprising each said associated set of parameters; and
transmitting, by said computing system to said calling system, said validation statuses.

17. The process of claim 16, wherein said method further comprises:
selecting, by said computing system, pseudo accounting elements from said configuration table, wherein said pseudo accounting elements are associated with said relevant accounting elements, wherein said pseudo accounting elements comprise relationships between sets of relevant accounting elements of said relevant accounting elements;
selecting, by said computing system, pseudo algorithms of said validation algorithms, wherein said pseudo algorithms are associated with said sets of relevant accounting elements; and
executing, by said computing system, each algorithm of said pseudo algorithms on an associated set of pseudo parameters of said parameters, wherein said generating said validation statuses is based on said executing each said algorithm of said pseudo algorithms on an associated set of pseudo parameters of said parameters.

18. The process of claim 16, wherein said relevant accounting elements each comprise an associated identification code in said configuration file.

19. The process of claim 16, wherein said purchasing scenario comprises a multi-element delimited key comprising an ID for an entity, a document type, a purchase type, a dependent entity, and a specified country.

20. The process of claim 16, wherein said executing each said algorithm of said validation algorithms is performed in a random order.
